(19) United States
(12) Patent Application Publication
(10) Pub. No.: US 2010/0223566 A1
(43) Pub. Date: Sep. 2, 2010

(54) Method and system for enabling interaction with a plurality of applications using a single user interface

(75) Inventors: Colin J. Holmes, Vancouver, WA (US); Monroe M. Thomas, Calgary (CA); Glen Lehmann, Crossfield (CA); Pierre Lemire, Calgary (CA)

Correspondence Address: Frank J. Bonini, Jr.;86 The Commons at Valley Forge East, 1288 Valley Forge Road, Post Office Box 750, Valley Forge, PA, 19482-0750, US

(73) Assignee: Calgary Scientific Inc., Calgary (CA)

(21) Appl. No.: 12/658,080

(22) Filed: Feb. 2, 2010

Related U.S. Application Data
(60) Provisional application No. 61/202,168, filed on Feb. 3, 2009.

(51) Int. Cl. G06F 3/048

(52) U.S. Cl. 715/764

(57) ABSTRACT

A method for simultaneously interacting with a plurality of application programs is provided. Using a processor an application interaction program having a plurality of application programs associated therewith is executed. Interactive functionalities of the plurality of application programs are associated with respective interaction zones. An interactive functionality being a same for at least two application programs is associated with a single interaction zone. Display data indicative of a single user interface comprising the interaction zones are then generated. The interaction zones enable user interaction with the plurality of application programs. Using a graphical display connected to the processor the display data are displayed in a human comprehensible fashion.

This application claims the benefit of U.S. Provisional Patent Application No. 61/202,168 filed Feb. 3, 2009, the entire contents of which are incorporated herein by reference.

### FIELD OF THE INVENTION

The instant invention relates to computer applications and in particular to a method and system for simultaneously interacting with a plurality of application programs using a single user interface.

### BACKGROUND

Techniques exist for the virtualization of single applications to allow users to interact with application programs while using a client computer remote to the computer on which the application is executed. Other techniques enable modeling and virtualizing of single applications such that an internal user interface and application state are available to a remote client computer.

Often multiple associated applications are used simultaneously in an overall workflow to accomplish a set of tasks. Currently these applications are launched individually with individual tools for their virtualization.

When a user has to interact simultaneously with two or more applications using a display monitor the applications typically employ display images that share the display area of the monitor. For example, a first application generates a first user interface using a first image window to enable user interaction with the first application. When launching a second application a second user interface using a second image window is generated to enable user interaction with the second application. The second image window is placed in the foreground overlaying the first image window when in response to user interaction with the second application. Thus the first image window is at least partially obscured. When the user then interacts with the first application the situation is vice versa. This is a non-user friendly process substantially impeding demanding user interaction such as viewing and diagnosing medical images.

It would be desirable to enable simultaneous user interaction with a plurality of application programs using a single user interface.

### SUMMARY OF EMBODIMENTS OF THE INVENTION

In accordance with embodiments of the present invention there is provided a method simultaneously interacting with a plurality of application programs. Using a processor an application interaction program is executed. The application interaction program has a plurality of application programs associated therewith. Using the processor interactive functionalities of the plurality of application programs are associated with respective interaction zones, wherein an interactive functionality being a same for at least two application programs is associated with a single interaction zone. Using the processor display data indicative of a single user interface comprising the interaction zones are generated. The interaction zones enable user interaction with the plurality of application programs. Using a graphical display connected to the processor the display data are displayed in a human comprehensible fashion.

In accordance with embodiments of the present invention there is provided a storage medium having stored therein executable commands for execution on a processor of a computer system, the processor when executing the commands executes an application interaction program. The application interaction program has a plurality of application programs associated therewith. The processor associates interactive functionalities of the plurality of application programs with respective interaction zones, wherein an interactive functionality being a same for at least two application programs is associated with a single interaction zone. The processor generates display data indicative of a single user interface comprising the interaction zones. The interaction zones enable user interaction with the plurality of application programs and provides the display data to a graphical display connected to the processor for displaying the display data in a human comprehensible fashion.

### BRIEF DESCRIPTION OF THE FIGURES

Exemplary embodiments of the invention will now be described in conjunction with the following drawings, in which:

FIG. 1 is a simplified block diagram of a system for implementing a method for simultaneously interacting with a plurality of application programs according to embodiments of the invention;

FIG. 2 is a simplified flow diagram of the method for simultaneously interacting with a plurality of application programs according to embodiments of the invention; and

FIG. 3 is a simplified block diagram illustrating a single navigable window for use with the method for simultaneously interacting with a plurality of application programs according to embodiments of the invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

Unless defined otherwise, all technical and scientific terms used herein have the same meaning as commonly understood by one of ordinary skill in the art to which the invention belongs.

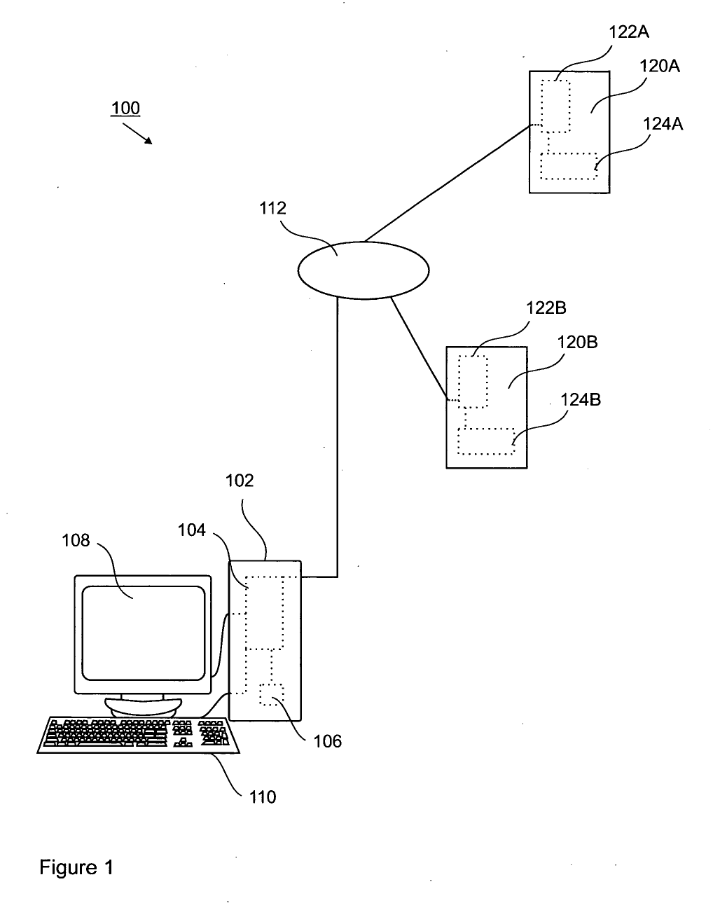

Referring to FIG. 1, an example 100 of a system for implementing a method for simultaneously interacting with a plurality of application programs according to embodiments of the invention described herein below is shown. The system 100 comprises a client computer 102 such as, for example, a personal computer or workstation for; viewing medical images of a patient and entering a diagnostic report into a respective patient application file. The client computer 102 is connected via a communication network 112 to server computers 120A and 120B. The server computers 120A and 120B are, for example, running different application programs for performing, for example, different image rendering processes of image data captured by different imaging systems such as MRI and CT scanners, and programs for managing patient files such as, for example, programs implemented in a PACS system. The communication network 112 comprises, for example, a Local Area Network (LAN) connecting the client computer 102 with the server computers 120A and 120B within an organization such as, for example, a hospital. Alternatively, the communication network 112 comprises a Wide Area Network (WAN) or the Internet connecting client computers and server computers of various organizations such as, for example, hospitals, diagnostic clinics, and family physicians offices.

The embodiments of the method for simultaneously interacting with a plurality of application programs according to the invention are performed, for example, by executing executable commands stored in memory 106 of the client computer 102 using processor 104. An application interaction program is then executed in dependence upon user requests. For example, the application interaction program provides commands to processors 122A and 122B of the server computers 120A and 120B to execute a first application program and a second application program, respectively. During execution the application interaction program enables simultaneous user interaction with both application programs while providing a single user interface which is displayed on display 108 of the client computer 102. Alternatively, one or more application programs are executed using the processor 104 of the client computer 102. The processor 104 for executing the application interaction program is, for example, a Central Processing Unit (CPU) of the client computer 102. Optionally, a Graphics Processing Unit (GPU) is employed executing at least a portion of the application interaction program, for example, for generating display data.

While embodiments of the invention will be described for simultaneously interacting with a plurality of application programs using a single user interface in a medical application for the sake of simplicity, it will become evident to those skilled in the art that the embodiments of the invention are not limited thereto, but are applicable in numerous other fields where simultaneous interaction with a plurality of application programs using a single user interface is desired.

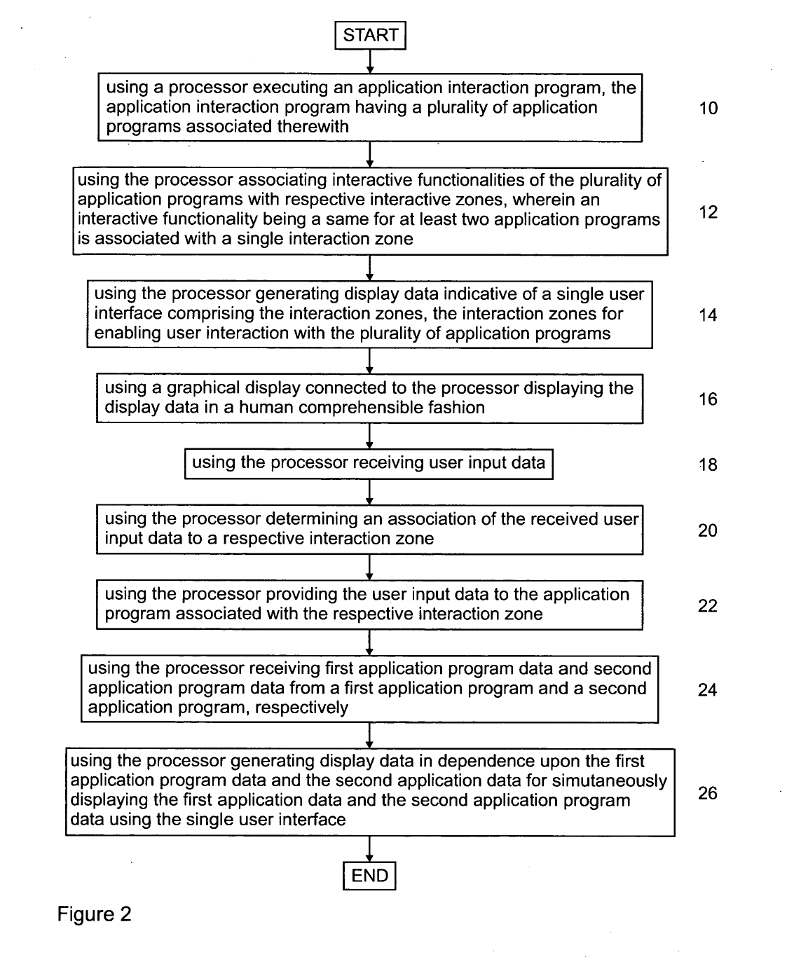

Referring to FIG. 2, a preferred embodiment of a method for simultaneously interacting with a plurality of application programs according to the invention is provided. At 10, the application interaction program having a plurality of application programs associated therewith is executed. The plurality of application programs is, for example, user selected with a user being presented with a selection menu comprising a plurality of buttons—each button associated with an application program. Alternatively, the plurality of application programs is already associated with the application interaction program, for example, application programs for needed performing a specific task by the user. At 12, interactive functionalities of the plurality of application programs are associated with respective interaction zones. An interactive functionality that is the same for at least two application programs is associated with a single interaction zone. The interactive functionalities of the plurality of application programs are, for example, simultaneously associated with respective interaction zones after the plurality of application programs has been selected. Alternatively, the interactive functionalities of the plurality of application programs are associated with respective interaction zones separately for each of the plurality of application programs. For example, after the user has selected a first application program the interactive functionalities of the first application program are associated with respective interaction zones and after the user has selected a second application program the interactive functionalities of the second application program are associated with respective interaction zones. If a functionality is in common with the first application program it is associated with the respective interaction zone of the first application program. Here a user is enabled to select an additional application program at a later time.

The associated interactive functionalities are, for example, a subset of the functionalities of an application program. For example, the user is presented with a menu for selecting the subset of the functionalities enabling the user to select functions, for example, related to viewing but to omit functions related to editing, thus avoiding clutter on the screen. Further optionally, the user is enabled to select additional functionalities during execution of the application program if a need arises. Alternatively, the subset of functionalities is predetermined, for example, depending on the task the user is going to use the plurality of application programs for or access limitations of the user.

At 14, display data indicative of a single user interface comprising the interaction zones are generated. The interaction zones enable the user to interact with the plurality of application programs. The display data are then displayed—16—in a human comprehensible fashion using the graphical display 108 connected to the processor 104.

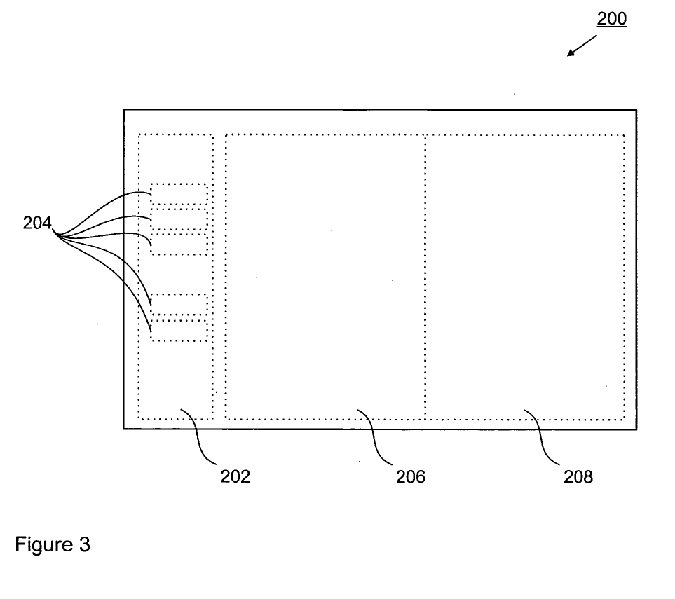

Referring to FIG. 3, an example outlay of a single user interface 200 is illustrated, but the embodiments of the invention are not limited thereto. The single user interface 200 is presented as a single navigable window which comprises a command field 202 with a plurality of interaction zones 204—for example, in the form of buttons—and display areas 206 and 208. The interaction zones 204 are, for example, clicked on by a mouse click, using keyboard 110 commands, or touched using a touch screen. The display areas are for displaying, for example, imaging data provided by a first application program—206—and a second application program—208. The interaction zones 204 are grouped, for example, according to the functionality they are associated with—for example, one group related to commands used for viewing and another group related to commands used for editing—and/or the respective application program. Optionally, the interaction zones 204 when clicked on open a scroll down menu for selection of specific functions or open a field for receiving user information, for example, a patient's name typed by the user.

At 18, user input data are received, i.e. user has clicked on an interaction zone 204. An association of the received user input data to the respective interaction zone is then determined—20—and provided to the application program associated with the respective interaction zone—22. If an interaction zone is associated with a functionality shared by at least two application programs the user input data are simultaneously provided to the at least two application programs associated with the single interaction zone. For example, the user is then enabled while viewing two sets of image data provided by two application programs—for example, a first application program for viewing CT scans and a second application program for viewing MRI data—which are simultaneously displayed in the display areas 206 and 208 to simultaneously move up and down in both images. Optionally, the user is enabled and to select one application program for provision of the user input data thereto.

At 24, first application program data and second application program data are received from a first application program and a second application program, respectively, and display data are generated—26—in dependence upon the first application program data and the second application program data which are then simultaneously displayed in the display areas 206 and 208 of the single user interface 200.

The embodiments of the invention enable simultaneous interaction with a plurality of application programs—including programs utilizing Graphic Processing Units (GPU)—in the overall workflow to accomplish a set of tasks using a single user interface. The simultaneous interaction is realized by monitoring events such as, for example, key strokes or mouse clicks with respect to the location of the event—the respective interaction zone—on the graphical display image. The received user input data are associated to a respective interaction zone—which is associated to a functionality of an application program—based on the location of the interaction zone in the graphical display image. The location is determined, for example, in a pixel-wise fashion, i.e. is based on a pixel by pixel understanding of the user interface. The application interaction program is implemented using standard programming languages, for example, programming languages based on PureWeb™ technology.

The present invention has been described herein with regard to preferred embodiments. However, it will be obvious to persons skilled in the art that a number of variations and modifications can be made without departing from the scope of the invention as described herein.

What is claimed is:

1. A method comprising:
using a processor executing an application interaction program, the application interaction program having a plurality of application programs associated therewith;
using the processor associating interactive functionalities of the plurality of application programs with respective interaction zones, wherein an interactive functionality being a same for at least two application programs is associated with a single interaction zone;
using the processor generating display data indicative of a single user interface comprising the interaction zones, the interaction zones for enabling user interaction with the plurality of application programs; and,
using a graphical display connected to the processor displaying the display data in a human comprehensible fashion.

2. A method as defined in claim 1 comprising:
using the processor receiving user input data;
using the processor determining an association of the received user input data to a respective interaction zone; and,
using the processor providing the user input data to the application program associated with the respective interaction zone.

3. A method as defined in claim 2 comprising:
using the processor receiving application program data in dependence upon the user input data; and,
using the processor generating display data in dependence upon the application program data for displaying the application program data using the single user interface.

4. A method as defined in claim 2 wherein the user input data are simultaneously provided to at least two application programs associated with a single interaction zone.

5. A method as defined in claim 2 comprising:
using the processor receiving first application program data and second application program data from a first application program and a second application program, respectively; and,
using the processor generating display data in dependence upon the first application program data and the second application program data for displaying the first application program data and the second application program data using the single user interface.

6. A method as defined in claim 5 wherein the display data are generated for simultaneously displaying the first application program data and the second application program data using the single user interface.

7. A method as defined in claim 2 wherein the association of the received user input data to a respective interaction zone is determined based on a location of the interaction zone on the graphical display image.

8. A method as defined in claim 7 wherein the association of the received user input data to a respective interaction zone is determined in a pixel-wise fashion.

9. A method as defined in claim 1 wherein the associated interactive functionalities are a subset of the functionalities of at least one of the plurality of application programs.

10. A method as defined in claim 9 wherein the subset is user selected.

11. A method as defined in claim 1 wherein the plurality of application programs associated with the application interaction program is user selected.

12. A method as defined in claim 11 wherein the interactive functionalities of the plurality of application programs are simultaneously associated with respective interaction zones.

13. A method as defined in claim 11 wherein the interactive functionalities of the plurality of application programs are associated with respective interaction zones separately for each of the plurality of application programs.

14. A storage medium having stored therein executable commands for execution on a processor of a computer system, the processor when executing the commands performing:
executing an application interaction program, the application interaction program having a plurality of application programs associated therewith;
associating interactive functionalities of the plurality of application programs with respective interaction zones, wherein an interactive functionality being a same for at least two application programs is associated with a single interaction zone;
generating display data indicative of a single user interface comprising the interaction zones, the interaction zones for enabling user interaction with the plurality of application programs; and,
providing the display data to a graphical display connected to the processor for displaying the display data in a human comprehensible fashion.

15. A storage medium as defined in claim 14 the processor when executing the commands further performing:
receiving user input data;
determining an association of the received user input data to a respective interaction zone; and,
providing the user input data to the application program associated with the respective interaction zone.

16. A storage medium as defined in claim 14 the processor when executing the commands further performing:
receiving application program data in dependence upon the user input data; and,
generating display data in dependence upon the application program data for displaying the application program data using the single user interface.
